(19) United States
(12) Patent Application Publication
(10) Pub. No.: US 2003/0094246 A1
(43) Pub. Date: May 22, 2003

(54) Vertical posts for flexible goods handling door with flexible curtain and industrial buildings

(76) Inventor: Bernard Simon, Caluire et Cuire (FR)

Correspondence Address: GREENBLUM & BERNSTEIN, P.L.C., 1950 ROLAND CLARKE PLACE, RESTON, VA, 20191, US

(21) Appl. No.: 10/257,390

(22) PCT Filed: Apr. 19, 2001
(86) PCT No.: PCT/FR01/01212

(30) Foreign Application Priority Data
Apr. 20, 2000 (FR) 00/05067

(51) Int. Cl. E06B 3/48

(52) U.S. Cl. 160/84.01

(57) ABSTRACT

The invention concerns a goods handling door with flexible curtain for industrial buildings comprising opposite vertical posts (2, 3), a flexible curtain (6) provided with horizontal crosspieces (10, 13), means for guiding (15) the flexible curtain (6) integral with the posts (2, 3), means for driving (4, 8) the flexible curtain (6) from an opening position to a closing position, said posts (2, 3) consisting each of at least two half-posts (18, 19) fixed to each other and between which are provided insulating means (27) arranged over the entire height of said posts (2, 3), each half-post (18, 19) comprising a vertical wall (21, 24) integral with a semirigid strip (17, 16) forming the guiding means (15), while at least one of the half-posts (18, 19) is closed opposite its vertical wall (21, 24) and over its entire length with an insulating fabric (29).

The present invention relates to a good handling door with flexible curtain for an industrial building, and more specifically to the vertical and opposed posts allowing vertical guidance of the flexible curtain as it moves from an open position to a closed position.

Doors of this kind which consist of vertical and opposed posts fixed against a wall of a building, on each side of an opening of a flexible curtain equipped with horizontal crosspieces, of means for guiding the flexible curtain which means are secured to the vertical posts, and of means for driving the flexible curtain from an open position to a closed position, are known.

Goods handling doors which exhibit a double-walled flexible curtain, between which walls an insulating element is provided, are known.

This type of door is more particularly provided for closing an opening made between two spaces at different temperatures such as, for example, industrial buildings which have refrigerated rooms for keeping foodstuffs.

When the handling doors are used to close an opening made between two spaces at different temperatures, it is found, because of this significant temperature difference, that ice forms on the flexible curtain, on the guide means and on the vertical and opposed posts.

The goods handling door with flexible curtain according to the present invention is aimed at responding to the abovementioned disadvantages and more particularly at solving the problem of heat exchange and the formation of ice on the vertical posts.

The goods handling door with flexible curtain for an industrial building according to the present invention comprises vertical and opposed posts, a flexible curtain equipped with horizontal crosspieces, means for guiding the flexible curtain which are secured to the posts and means for driving the flexible curtain from an open position to a closed position, each said post consisting of at least two half-posts fixed together and between which insulating means arranged over the entire height of said posts are provided, each half-post comprising a vertical wall secured to a semi-rigid leaf constituting the guide means, while at least one of the two half-posts is closed on the opposite side to its vertical wall and over its entire height by an insulating fabric.

The goods handling door with flexible curtain for an industrial building according to the present invention comprises a half-post which is produced from a C-section comprising perpendicularly and at each end of its vertical wall, two vertical flanges, said wall being secured, in an opposite direction to that of said flanges, to a semi-rigid leaf (17).

The goods handling door with flexible curtain for an industrial building according to the present invention comprises a half-post which is produced from a C-section comprising perpendicularly and at each end of its vertical wall, two vertical flanges, said wall being secured, in an opposite direction to that of said flanges, to a semi-rigid leaf.

The goods handling door with flexible curtain for an industrial building according to the present invention comprises insulating means which are arranged in the same vertical plane in which the flexible curtain runs, so as to avoid heat exchanges due to the temperature difference between two spaces (A, B).

The goods handling door with flexible curtain for an industrial building according to the present invention comprises insulating means which consist of a strip of foam arranged vertically between the half-posts.

The goods handling door with flexible curtain for an industrial building according to the present invention comprises a fabric which is fixed on the opposite side to the vertical walls of each half-post by detachable means.

The vertical post for a goods handling door with flexible curtain according to the present invention consists of at least two half-posts fixed together and between which insulating means arranged over the entire height of said posts are provided, each half-post comprising a vertical wall secured to a semi-rigid leaf constituting means for guiding the flexible curtain of the goods handling door, while at least one of the half-posts is closed on the opposite side to its vertical wall and over its entire height by an insulating fabric.

The vertical posts for a goods handling door with flexible curtain according to the present invention comprises a half-post which is produced from a C-section comprising perpendicularly and at each end of its vertical wall, two vertical flanges, said wall being secured, in an opposite direction to that of said flanges, to a semi-rigid leaf.

The vertical post for a goods handling door with flexible curtain according to the present invention comprises a half-post which is produced from a C-section comprising perpendicularly and at each end of its vertical wall, two vertical flanges, said wall being secured, in an opposite direction to that of said flanges, to a semi-rigid leaf.

Post string comprises insulating means which are arranged in the same vertical plane in which the flexible curtain runs, so as to avoid heat exchanges due to the temperature difference between two spaces (A, B).

Post string comprises insulating means which consist of a strip of foam arranged vertically between the half-posts.

Post string comprises a fabric which is fixed on the opposite side to the vertical walls of each half-post by detachable means.

The description which will follow with reference to the appended drawings given by way of nonlimiting examples will allow for a better understanding of the invention, the characteristics it has and the advantages it is likely to afford:

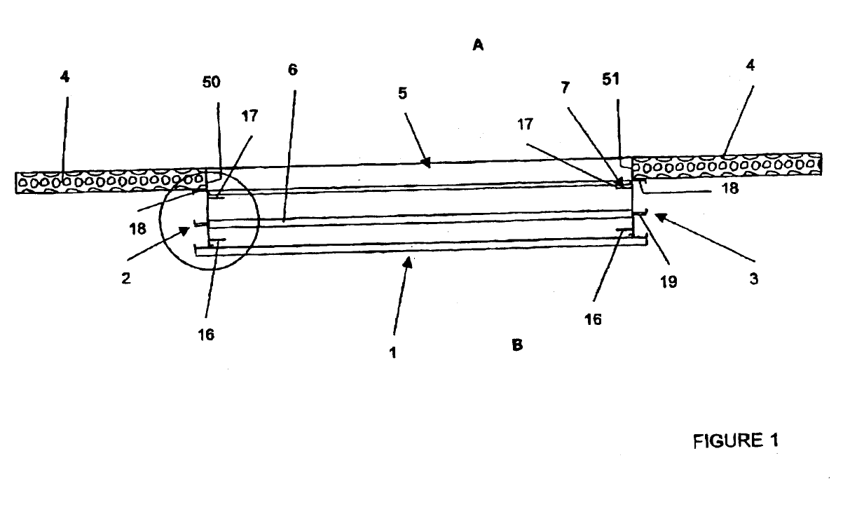

FIG. 1 is a view from above illustrating a goods handling door with flexible curtain according to the present invention.

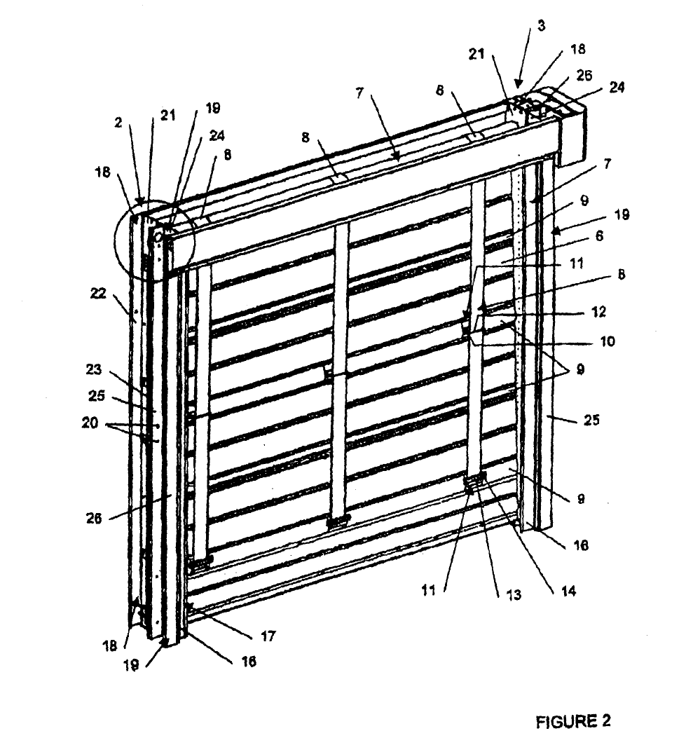

FIG. 2 is a perspective view illustrating a goods handling door with flexible curtain according to the present invention in the closed position.

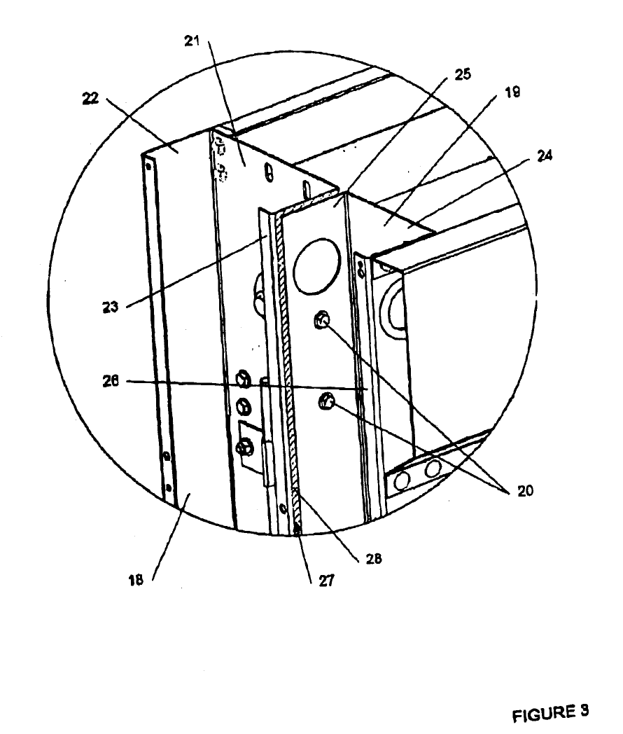

FIG. 3 is a perspective view depicting, in detail, the upper part of a vertical post of the goods handling door with flexible curtain according to the present invention.

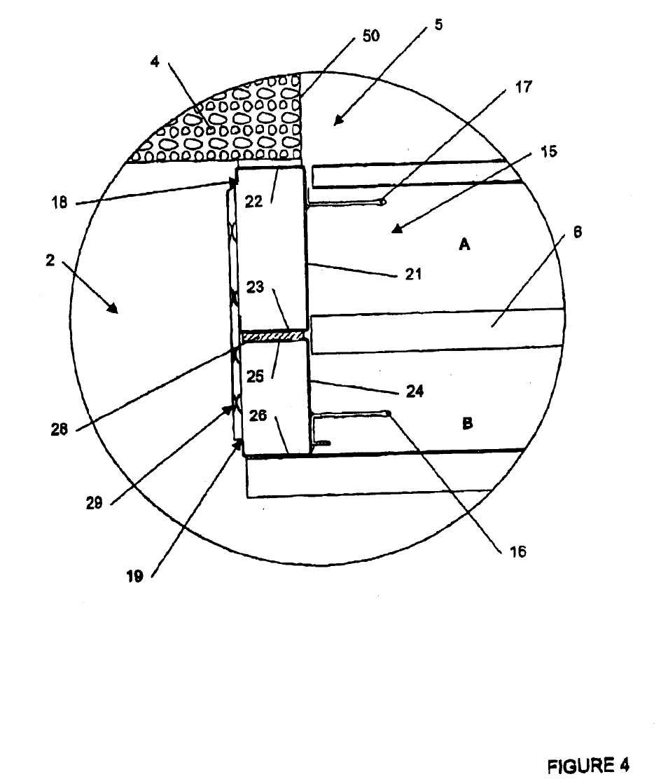

FIG. 4 is a view from above showing, in detail, a vertical post of the goods handling door with flexible curtain according to the present invention.

FIGS. 1 and 2 show a goods handling door 1 for industrial buildings, comprising two lateral and opposed posts 2 and 3 which are fixed against the vertical walls 4 of an opening 5 that is to be closed and of a flexible curtain 6.

The vertical and opposed posts 2 and 3 are connected together at the upper part of the goods handling door 1 by a winding drum 7 which, by means of hauling straps 8, allows the flexible curtain 6 to be moved between an open position and a closed position.

The flexible curtain 6 is formed of a double skin with internal insulation to allow the goods handling door 1 to be used between two spaces A and B of different temperatures. Specifically, the space A is designed to be at a positive temperature whilst the space B is at a negative temperature.

The flexible curtain 6 has sheets 9 each of which in its internal part accommodates horizontal reinforcing crosspieces 10.

Certain sheets 9 of the flexible curtain 6 have openings 11 to allow each hauling strap 8 to be connected to the corresponding horizontal crosspiece 10 via strap loops 12.

The flexible curtain 6 comprises in its lower part, and inside a sheet 9, a horizontal crosspiece 13 which is connected by a fixing device 14 to the hauling straps 8.

Each vertical post 2, 3 comprises a guide device 15 allowing the flexible curtain 6 and the horizontal crosspieces 10, 13 to be guided as said curtain moves vertically.

For example, the guide device 15 provided on each post 2, 3 has two semi-rigid leaves 16, 17 arranged one facing the other, as has been described in patent applications FR 0000719 and FR 0000721 belonging to the applicant.

FIGS. 3 and 4 depict, in detail, the makeup of the vertical post 2 of the goods handling door 1, in the knowledge that the opposite post 3 is identical.

Thus, each vertical post 2, 3 comprises a rear half-post 18 and a front half-post 19 which are joined together over the entire height of the post 2, 3 by fixing screws 20.

The rear half-post 18 is made as a C-section comprising a vertical wall 21 and extended at each end by two vertical flanges 22 and 23 arranged facing each other in two planes which are parallel and perpendicular to the plane containing the wall 21.

The front half-post 19 is made as a C-section comprising a vertical wall 24 and extended at each end by two vertical flanges 25 and 26 arranged facing each other in two planes which are parallel and perpendicular to the one containing the wall 24.

In this exemplary embodiment, it is noted that the half-post 18 has a dimension between its two flanges 22, 23 which exceeds the dimension between the two flanges 25, 26 of the half-post 19. This configuration is not compulsory for the production of the vertical posts 2 and 3 and in no way changes the subject of the present invention.

As far as the vertical post 2 is concerned, it can be seen that the flange 22 allows the half-post 18 to be fixed against the vertical wall 4 forming the partition, so that the vertical wall 21 lies in the same vertical plane as the one containing the edge 50 of the opening 5.

The vertical wall 21 of the half-post 18 forming the post 2 is secured, on its outside face, and at right angles to the latter, to the semi-rigid leaf 17 of the guide device 15. The semi-rigid leaf 17 is arranged so that it runs in the opposite direction to that of the flanges 22 and 23 of the half-post 18.

The vertical post 2 comprises a half-post 19 which is fixed in the continuation of the half-post 18.

The half-post 19 is arranged in such a way that its vertical flange 25 faces the one 23, and its vertical wall 24 lies in the continuation of that 21 of the half-post 18.

The vertical wall 24 of the half-post 19 forming the post 2 is secured, on its outside face, and at right angles to the latter, to the semi-rigid leaf 16 of the guide device 15. The semi-rigid leaf 16 is arranged so that it runs in the opposite direction to that of the flanges 25 and 26 of-the half-post 19.

Before the half-posts 18, 19 are joined together, insulating means 27 are placed between the vertical flanges 23 and 25 to insulate the vertical post 2 against temperature differences between the spaces A and B.

The half-posts 18 and 19 are joined together by fixing screws 20 which pass through the flanges 23 and 25 and the insulating means 27, and which are distributed over the entire height of the vertical post 2.

As far as the vertical post 3 is concerned, it can be seen that the flange 23 allows the half-post 18 to be fixed against the vertical wall 4, forming the partition, so that the vertical wall 21 lies in the same vertical plane as the one containing the edge 51 of the opening 5 which is the opposite edge to the edge 50.

The vertical wall 21 of the half-post 18 forming the post 3 is secured, on its outside face, and at right angles to the latter, to the semi-rigid leaf 17 of the guide device 15. The semi-rigid leaf 17 is arranged so that it runs in the opposite direction to that of the flanges 22 and 23 of the half-post 18.

The vertical post 3 comprises a half-post 19 which is fixed in the continuation of the half-post 18.

The half-post 19 is arranged in such a way that its vertical flange 26 faces the one 22, and its vertical wall 24 lies in the continuation of that 21 of the half-post 18.

The vertical wall 24 of the half-post 19 forming the post 3 is secured, on its outside face, and at right angles to the latter, to the semi-rigid leaf 16 of the guide device 15. The semi-rigid leaf 16 is arranged so that it runs in the opposite direction to that of the flanges 25 and 26 of the half-post 19.

Before the half-posts 18, 19 are joined together, insulating means 27 are placed between the vertical flanges 22 and 26 to insulate the vertical post 3 against temperature differences between the spaces A and B.

The half-posts 18 and 19 are joined together by fixing screws 20 which pass through the flanges 22 and 26 and the insulating means 27, and which are distributed over the entire height of the vertical post 3.

The insulating means 27 consist of a vertical strip 28 made of an insulating foam arranged over the entire height of the vertical post 2, 3 to reduce heat exchanges between the half-posts 18 and 19 due to the temperature difference between the spaces A and B.

It can be seen that, for each post 2, 3, the insulating means 27 are arranged in the same vertical plane in which the flexible curtain 6 of the goods handling door 1 runs so as to avoid heat exchanges due to the temperature difference between the two spaces A and B.

As an alternative, FIG. 4 shows that the posts 2 and 3 may be closed on the opposite side to the walls 21 and 24 by an insulating fabric 29 arranged over the entire height of said posts. The fabric 29 may consist of a double skin between which an insulating foam is introduced.

The fabric 29 is attached to the turned-back edges of the flanges 22, 23 and 26 of the half-posts 18 and 19, in the case of the post 2, and to the turned-back edges of the flanges 22, 23 and 25 of the half-posts 18 and 19 in the case of the post 3, by a “VELCRO” system.

The fabric 29 makes it possible to improve the insulation of the posts 2, 3 so as to avoid heat exchanges due to the difference in temperature between the space A and B.

What happens is that it is found that one of the half-posts has an external temperature which differs from that of the other half-post because of the temperature in each space A and B.

1. A goods handling door with flexible curtain for an industrial building comprising vertical and opposed posts (2, 3), a flexible curtain (6) equipped with horizontal crosspieces (10, 13), means (15) for guiding the flexible curtain (6) which are secured to the posts (2, 3) and means (4, 8) for driving the flexible curtain (6) from an open position to a closed position, characterized in that each post (2, 3) consists of at least two half-posts (18, 19) fixed together and between which insulating means (27) arranged over the entire height of said posts (2, 3) are provided, each half-post (18, 19) comprising a vertical wall (21, 24) secured to a semi-rigid leaf (17, 16) constituting the guide means (15), while at least one of the two half-posts (18, 19) is closed on the opposite side to its vertical wall (21, 24) and over its entire height by an insulating fabric (29).

2. The goods handling door with flexible curtain as claimed in claim 1, characterized in that the half-post (18) is produced from a C-section comprising perpendicularly and at each end of its vertical wall (21), two vertical flanges (22, 23), said wall (21) being secured, in an opposite direction to that of said flanges, to a semi-rigid leaf (17).

3. The goods handling door with flexible curtain as claimed in claim 1, characterized in that the half-post (19) is produced from a C-section comprising perpendicularly and at each end of its vertical wall (24), two vertical flanges (25, 26), said wall (24) being secured, in an opposite direction to that of said flanges, to a semi-rigid leaf (16).

4. The goods handling door with flexible curtain as claimed in claim 1, characterized in that the insulating means (27) are arranged in the same vertical plane in which the flexible curtain (6) runs, so as to avoid heat exchanges due to the temperature difference between two spaces (A, B).

5. The goods handling door with flexible curtain as claimed in claim 7, characterized in that the insulating means (27) consist of a strip of foam (28) arranged vertically between the half-posts (18, 19).

6. The goods handling door with flexible curtain as claimed in claim 9, characterized in that the fabric (29) is fixed on the opposite side to the vertical walls (21, 24) of each half-post (18, 19) by detachable means.

7. A vertical post for a goods handling door with flexible curtain (6), characterized in that it consists of at least two half-posts (18, 19) fixed together and between which insulating means (27) arranged over the entire height of said posts (2, 3) are provided, each half-post (18, 19) comprising a vertical wall (21, 24) secured to a semi-rigid leaf (17, 16) constituting means (15) for guiding the flexible curtain (6) of the goods handling door, while at least one of the half-posts (18, 19) is closed on the opposite side to its vertical wall (21, 24) and over its entire height by an insulating fabric (29).

8. The vertical post for a goods handling door with flexible curtain as claimed in claim 7, characterized in that the half-post (18) is produced from a C-section comprising perpendicularly and at each end of its vertical wall (21), two vertical flanges (22, 23), said wall (21) being secured, in an opposite direction to that of said flanges, to a semi-rigid leaf (17).

9. The vertical post for a goods handling door with flexible curtain as claimed in claim 7, characterized in that the half-post (19) is produced from a C-section comprising perpendicularly and at each end of its vertical wall (24), two vertical flanges (25, 26), said wall (24) being secured, in an opposite direction to that of said flanges, to a semi-rigid leaf (16).

10. The vertical post for a goods handling door with flexible curtain as claimed in claim 7, characterized in that the insulating means (27) are arranged in the same vertical plane in which the flexible curtain (6) runs, so as to avoid heat exchanges due to the temperature difference between two spaces (A, B).

11. The vertical post for a goods handling door with flexible curtain as claimed in claim 7, characterized in that the insulating means (27) consist of a strip of foam (28) arranged vertically between the half-posts (18, 19).

12. The vertical post for a goods handling door with flexible curtain as claimed in claim 7, characterized in that the fabric (29) is fixed on the opposite side to the vertical walls (21, 24) of each half-post (18, 19) by detachable means.
